(19) United States
(12) Patent Application Publication
(10) Pub. No.: US 2003/0215220 A1
(43) Pub. Date: Nov. 20, 2003

(54) Electronic camera, method of controlling an electronic camera, recording medium, and image processing device

(75) Inventors: Akira Ohmura, Kawasaki-shi (JP); Shoei Nakamura, Yokohama-shi (JP)

Correspondence Address: OLIFF & BERRIDGE, PLC, P.O. Box 19928, Alexandria, VA, 22320, US

(73) Assignee: Nikon Corporation

(21) Appl. No.: 10/385,626

(22) Filed: Mar. 12, 2003

Related U.S. Application Data
(63) Continuation of application No. 09/176,890, filed on Oct. 22, 1998, now abandoned.

(30) Foreign Application Priority Data
Oct. 24, 1997 (JP) 9-291983

(51) Int. Cl. H04N 5/76; H04N 5/225

(52) U.S. Cl. 386/117; 348/207.99

(57) ABSTRACT

When an image that is shot by an electronic camera is output to a display device as a display, differences in the appearance of color of the image for every different display device are accommodated. A CPU reads out a shot image to be printed from a memory card. Then, it reads out a profile from the memory card to correct discrepancies in the appearance of the color of the image that are caused by display characteristics or the visual environment of an LCD 6, and performs correction processing to the read out shot image with reference to data concerning the visual environment that is output from a photometry element and/or a colorimetry element. Then, the CPU causes the LCD to display the obtained data. Additionally, the CPU reads out a profile from the memory card to correct discrepancies in the appearance of the color of the image caused by the printing characteristics of the printer or the characteristics of the recording paper, and performs correction processing to the shot image read out from the memory card in accordance with this profile. Furthermore, the CPU reads out the information concerning the shooting environment at the time the image was shot from the memory card, and prints out the obtained image data after performing correction processing corresponding to the read out information.

### BACKGROUND OF THE INVENTION

The disclosure of the following priority application is herein incorporated by reference:

Japanese Patent Application No. 9-291983 filed on Oct. 24, 1997.

1. Field of Invention

This invention relates to an electronic camera, a method of controlling an electronic camera, and a recording medium. In particular, the invention relates to an electronic camera, a method of controlling an electronic camera, and a recording medium by which an image of an object that has been shot can be output to peripheral equipment such as a printer.

2. Description of Related Art

In a conventional electronic camera, when an image that has been shot is printed, an image to be printed is temporarily displayed on a color LCD (Liquid Crystal Display) or the like and confirmed, and then printed out, for example, by a color printer or the like.

### SUMMARY OF THE INVENTION

The electronic camera of this invention includes: a converter to convert an optical image of an object to corresponding image data; a memory to record the image data obtained by the converter; a reader to read desired image data that has been recorded in the memory; a selector to select a desired display device to display the image data that has been read by the reader; a processor to perform image processing corresponding to a display device that has been selected by the selector for the image data read by the reader; and an outputting part to output the image data, to which the image processing has been performed by the processor, to a display device selected by the selector.

### BRIEF DESCRIPTION OF THE DRAWINGS

FIG. 1 is a front perspective view of an electronic camera according to one embodiment of the invention.

FIG. 2 is a rear perspective view of the electronic camera 1 shown in FIG. 1.

FIG. 3 is a perspective view showing the electronic camera 1 while the LCD cover 14 is closed.

FIG. 4 is a perspective view showing an internal structure of the electronic camera 1 shown in FIGS. 1 and 2.

FIGS. 5A, B, and C are diagrams explaining the relationship of the position of the LCD cover 14 to the power switch 11 and to the LCD switch 25.

FIG. 6 is a block diagram showing an internal electrical structure of the electronic camera shown in FIGS. 1 and 2.

FIG. 7 is a diagram explaining a process of thinning pixels during the L mode.

FIG. 8 is a diagram explaining a process of thinning pixels during the H mode.

FIG. 9 is a diagram showing an example of a display screen of the electronic camera shown in FIGS. 1 and 2.

FIG. 10 is a diagram showing the electronic camera connected to a printer.

FIG. 11 is a flow chart explaining one example of a process for performing setting of the shooting mode of the electronic camera.

FIG. 12 is a display example of the image displayed on the LCD when the processing of step S1 of FIG. 11 is performed.

FIG. 13 is a display example of the image displayed on the LCD when the processing of step S3 of FIG. 11 is performed.

FIG. 14 is a flow chart explaining one example of a process for performing the printer setting.

FIG. 15 is a display example of an image displayed when the processing shown in FIG. 14 is performed.

FIG. 16 is a flow chart explaining one example of a process performed when a shot image is printed.

FIG. 17 is a display example of an image displayed on the LCD when step S40 of FIG. 16 is performed.

FIG. 18 is a flow chart explaining details of step S44 of FIG. 16.

FIG. 19 is a flow chart explaining details of step S46 of FIG. 16.

FIG. 20 is a flow chart explaining details of step S48 of FIG. 16.

FIG. 21 is a display example of an image displayed on the LCD when step S47 of FIG. 16 is performed.

FIG. 22 is a flow chart explaining one example of printing processing through a conditional search performed in the electronic camera 1.

FIG. 23 is a display example of an image displayed on the LCD when the processing step S90 of FIG. 22 is performed.

### DETAILED DESCRIPTION OF PREFERRED EMBODIMENTS

The following explains the embodiments of this invention with reference to the drawings.

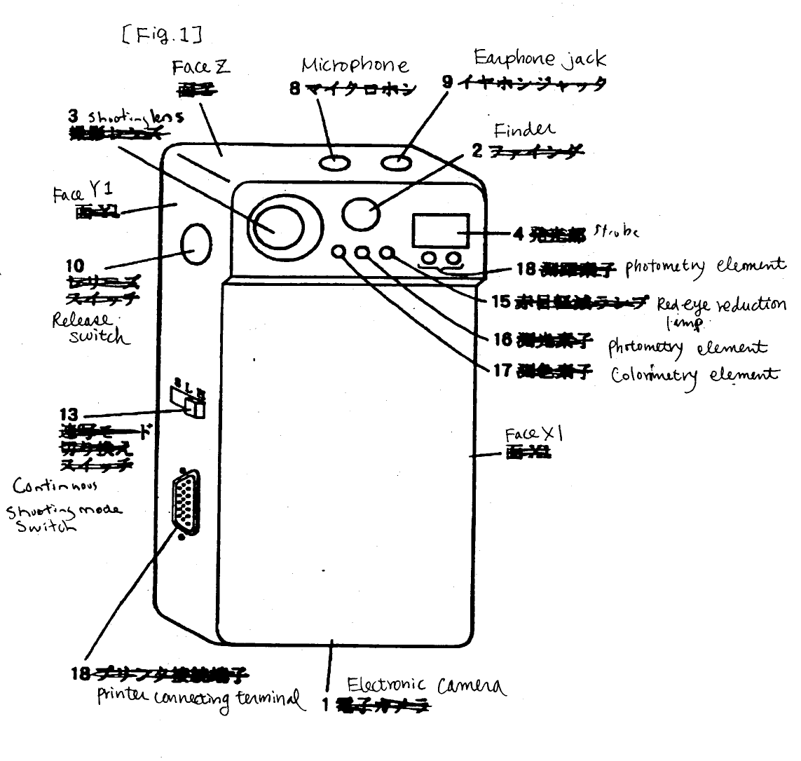

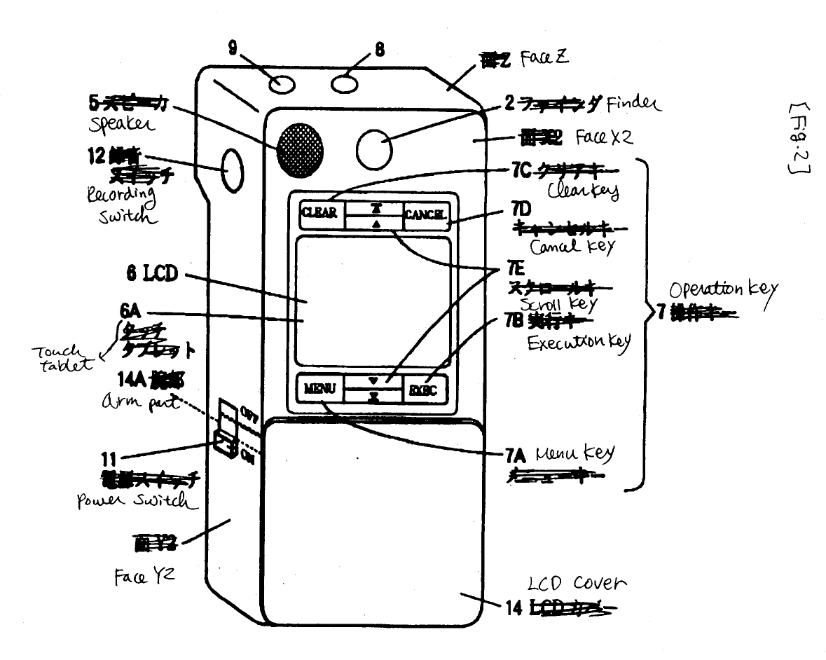

FIGS. 1 and 2 are perspective views showing the structure of one embodiment of an electronic camera to which this invention is applied. In the electronic camera of this embodiment, when an object is shot, the face facing toward an object is defined as face X1, and the face facing toward the user is defined as face X2. A viewfinder 2, which is used to confirm a shooting area of the object, a shooting lens 3 that takes in an optical image of the object, and a flash part (strobe) 4 that emits light to illuminate the object are disposed at the top of the face X1.

A red-eye reduction lamp 15 which, when light is emitted from the strobe 4 and the image is shot, reduces red eye by emitting light before emitting light from the strobe 4, a photometry element 16 that performs photometry when the operation of the CCD 20 is stopped, and a colorimetry element 17 to perform colorimetry when the operation of the CCD is stopped are disposed in the face X1.

Meanwhile, a speaker 5 that outputs sound which is recorded in the electronic camera 1 and the above-mentioned viewfinder 2 are disposed at the top of the face X2 opposite the face X1 (at the position corresponding to the top where the viewfinder 2, the operation lens 3, and light emitting part 4 are formed). Furthermore, operation keys 7 and an LCD 6 are formed in the face X2 below the viewfinder 2, the shooting lens 3, the light emitting part 4, and the speaker 5. A so-called touch tablet 6A, which outputs position data corresponding to the designated position by the contacting operation of a pen-type designating device, which will be discussed later, is disposed on the surface of the LCD 6.

This touch tablet 6A is structured by transparent material such as glass or resin. The user can observe the image displayed on the LCD 6, which is formed inside of the touch tablet 6A, through the touch tablet 6A.

The operation keys 7 are keys that are operated when recorded data is reproduced and displayed on the LCD 6. The operation keys 7 detect operation (input) by the user and supply this input to the CPU 39. A menu key 7A among the operation keys 7 is a key that is operated when the menu screen is displayed on the LCD 6. An executing key 7B is a key that is operated when the recorded information that has been selected by the user is reproduced.

A clear key 7C is a key that is operated when recorded information is deleted. A cancel key 7D is a key that is operated when the reproduction processing of the recorded information is interrupted. A scroll key 7E is a key that is operated when the screen is scrolled in the up and down directions when a list of the recorded information is displayed on the LCD 6.

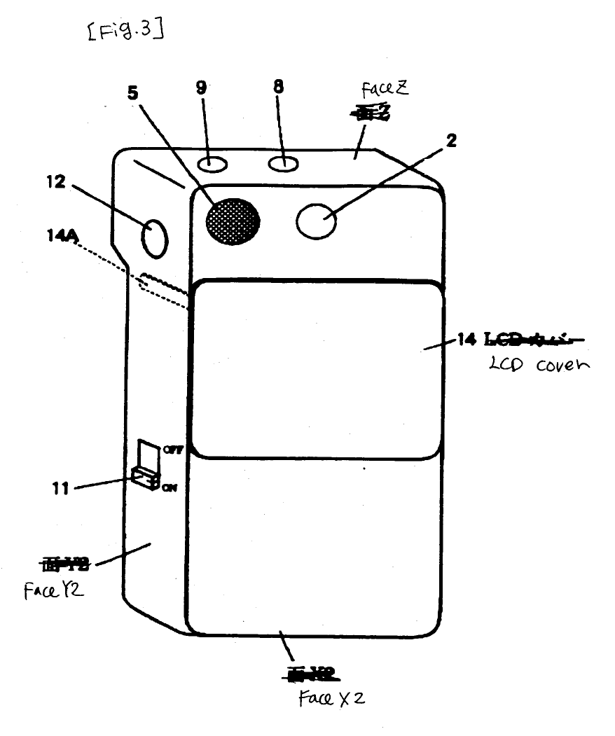

An LCD cover 14, which is slidable and which protects the LCD 6 when it is not being used, is disposed on the face X2. When the LCD cover 14 is moved in the upward direction, as shown in FIG. 3, it covers both the LCD 6 and the touch tablet 6A. Furthermore, when the LCD cover 14 is moved in the downward direction, both the LCD 6 and the touch tablet 6A appear and the power switch 11 (which will be discussed later), which is disposed in the face Y2, can be changed to an on state by an arm part 14A of the LCD cover 14.

A microphone 8 that collects sound and an earphone jack 9 that is connectable to an earphone, which is not depicted, are disposed in the face Z, which is the top face of the electronic camera 1.

In the left side face (face Y1), a release switch 10, which is operated when an object is imaged, a continuous shooting mode changeover switch 13, which is operated when the continuous shooting mode is changed during shooting, and a printer connecting terminal 18 to be connected to a printer, which will be discussed later, are disposed. The release switch 10 and the continuous shooting mode changeover switch 13 are disposed at positions that are lower than the positions of the viewfinder 2, the shooting lens 3, and the light emitting part 4, which are disposed on the top part of the face X1.

Meanwhile, in the face Y2 opposite the face Y1 (right side face), a recording switch 12, which is operated when sound is recorded, and the power switch 11 are disposed. Just like the above-mentioned release switch 10 and the continuous shooting mode changeover switch 13, the recording switch 12 and the power switch 11 are disposed at positions that are lower than the positions of the viewfinder 2, the shooting lens 3, and the light emitting part 4, which are disposed on the top part of the face X1. Additionally, the recording switch 12 is formed at substantially the same height as the release switch 10 of the face Y1. The recording switch 12 is structured so as to be operable without discomfort whether the user uses the right or the left hand to hold the electronic camera 1.

Furthermore, the height of the recording switch 12 and the release switch 10 may be made different so that, when the opposite side face is held by a finger in order to cancel a moment induced when one switch is pressed, the switch which is disposed on the opposite side will not be pressed by mistake.

The above-mentioned continuous shooting mode changeover switch 13 is used to establish whether the object is shot for one frame or for a plurality of frames when the user shoots the object by pressing the release switch 10. For example, when the indicator of the continuous shooting mode changeover switch 13 is changed over to a position where S is printed (that is, it is changed to the S mode), when the release switch 10 is pressed, one frame of shooting is performed.

Furthermore, when the indicator of the continuous shooting mode changeover switch 13 is changed to a position where L is printed (that is, it is changed to the L mode), when the release switch 10 is pressed, 8 frames of shooting is performed per one second (that is, it becomes a low speed continuous shooting mode).

In addition, when the indicator of the continuous shooting mode changeover switch 13 is changed to a position where H is printed (that is, it is changed to the H mode), when the release switch 10 is pressed, 30 frames of shooting is performed per one second (that is, it becomes a high speed continuous shooting mode).

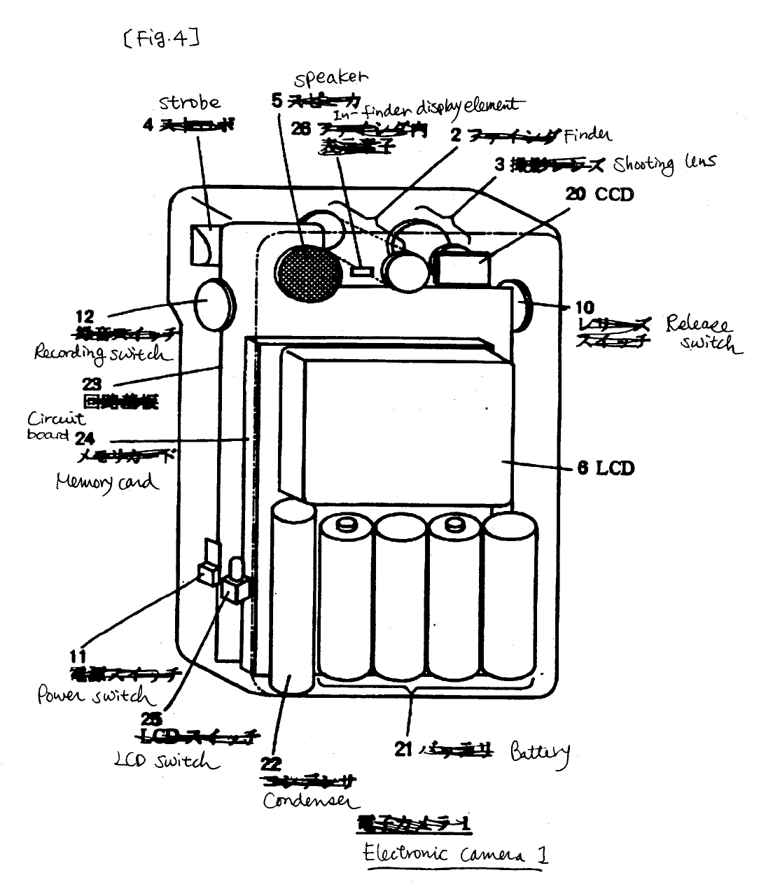

Next, the internal structure of the electronic camera 1 is explained. FIG. 4 is a perspective view showing an example of the internal structure of the electronic camera shown in FIGS. 1 and 2. The CCD 20 is disposed behind the shooting lens 3 (face X2 side). The optical image of the object that is image-formed through the shooting lens 3 is photoelectrically converted to electrical signals by the CCD 20.

The in-finder display element 26 is disposed within the field of view of the viewfinder 2, and the setting state of various functions or the like can be displayed to a user who is observing the object through the viewfinder 2.

Below the LCD 6, four cylindrical batteries (AAA dry cells) 21 are vertically arranged and the power that is accumulated in the batteries 21 is supplied to each part of the camera. Furthermore, below the LCD 6, along with the batteries 21, a condenser 22 is disposed that accumulates a charge to cause the light emitting part 4 to emit light.

In the circuit board 23, various control circuits are formed to control each part of the electronic camera 1. Furthermore, between the circuit board 23 and the LCD 6 and the batteries 21, an insertable memory card 24 is disposed on which various information input to the electronic camera 1 are recorded, respectively, in areas of the memory card 24, which are set in advance.

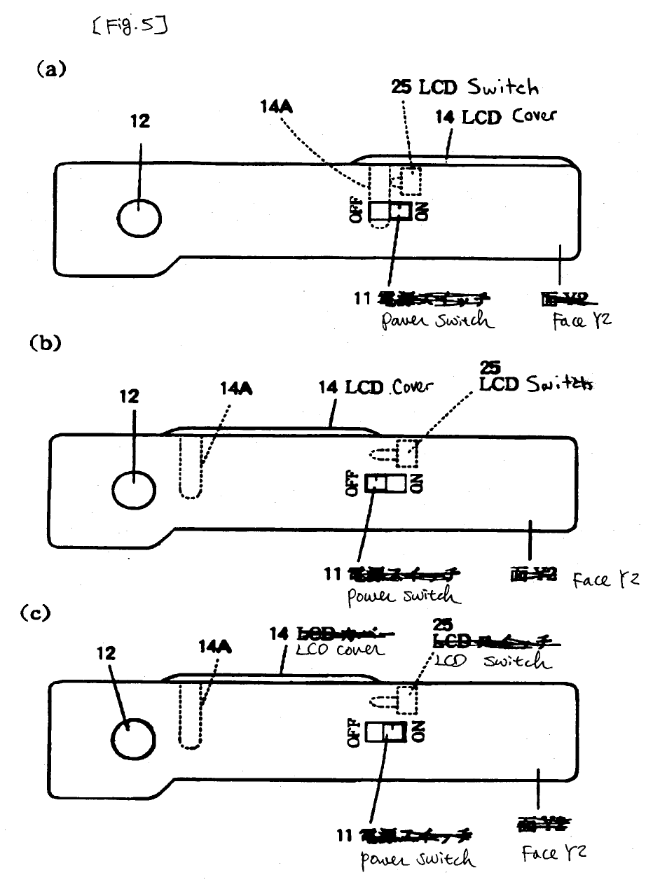

In addition, an LCD switch 25, which is disposed adjacent to the power switch 11, is placed in an ON state only while its plunger is pressed. When the LCD cover 14 is moved in the downward direction, as shown in FIG. 5A, the LCD switch 25 can be changed to an ON state, along with the power switch 11, by the arm member 14A of the LCD cover 14.

Furthermore, when the LCD cover 14 is positioned in the upper direction, the power switch 11 can be operated by the user separately from the LCD switch 25. For example, when the LCD cover 14 is closed and the electronic camera 1 is not used, as shown in FIG. 5B, the power switch 11 and the LCD switch 25 are in the OFF state. In this state, as shown in FIG. 5C, when the user turns the power switch 111 to an ON state, the power switch II is placed in the ON state, but the LCD switch 25 still remains in the OFF state. Meanwhile, as shown in FIG. 5B, when the power switch 11 and the LCD switch 25 are in the OFF state, if the LCD cover 14 is opened, as shown in FIG. 5A, the power switch 11 and the LCD switch 25 are placed in the ON state. Furthermore, after this, when the LCD cover 14 is closed, as shown in FIG. 5C, only the LCD switch 25 is placed in the OFF state.

Additionally, in the present embodiment, the memory card 24 is insertable, but it is also acceptable to provide a memory on the circuit board 23 and to record various information in the memory. Furthermore, it is also acceptable to output various information recorded in the memory (memory card 24) to an external personal computer through an undepicted interface.

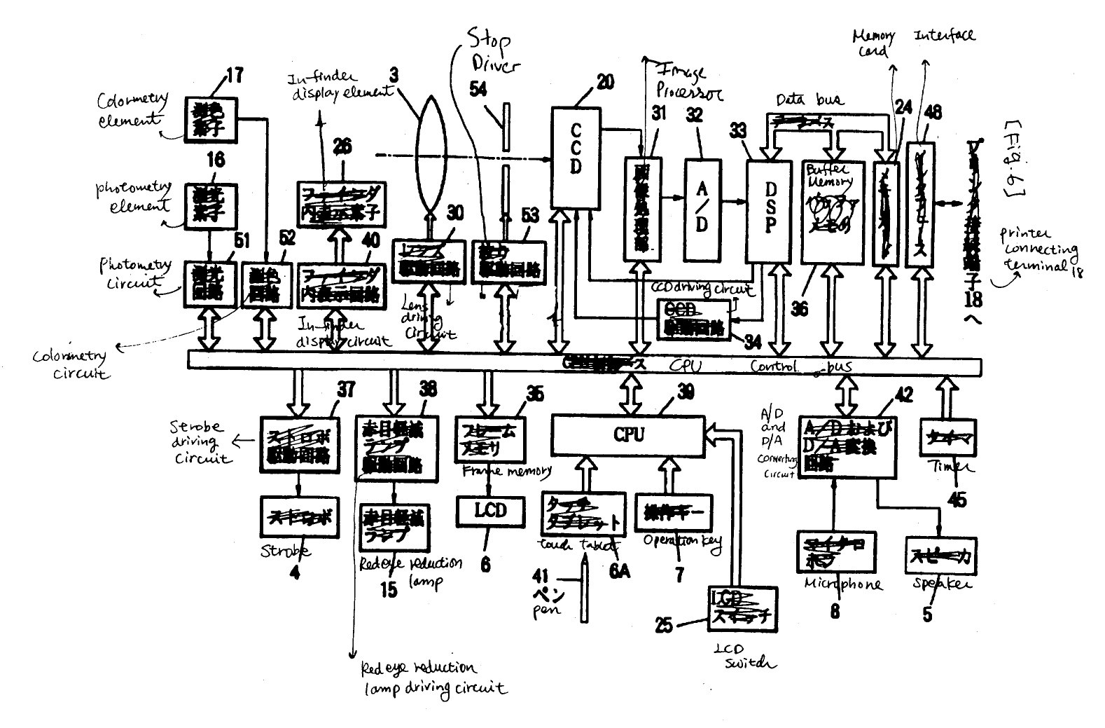

Next, the internal electrical structure of the electronic camera 1 of the present embodiment is explained by referring to the block diagram of FIG. 6. The CCD 20, which has a plurality of pixels, can photoelectrically convert an optical image that has been image-formed in each pixel to an image signal (electrical signal). The digital signal processor (hereafter referred as to DSP) 33 supplies a CCD horizontal driving pulse to the CCD 20, controls the CCD driving circuit 34, and supplies a CCD vertical driving pulse to the CCD 20.

The image processor 31 is controlled by the CPU 39, and samples the image signals that have been photoelectrically converted by the CCD 20 at a specified timing, and the sampled signals are amplified to a specified level. The analog/digital converter (hereafter referred as to A/D converter) 32 digitizes the image signals that have been sampled by the image processor 31 and the image signals are supplied to the DSP 33.

The DSP 33 controls a data bus that is connected to a buffer memory 36 and to the memory card 24. After the image data that has been supplied from the A/D converter 32 is temporarily recorded into the buffer memory 36, the image data that has been recorded in the buffer memory 36 is read, and the image data is recorded into the memory card 24.

In addition, the DSP 33 stores the image data that has been supplied by the A/D converter 32 into the frame memory 35, displays it on the LCD 6, and reads the shot image data from the memory card 24. After the shot image data is decompressed, the decompressed image data is stored in the frame memory 35 and is displayed on the LCD 6.

Furthermore, during activation of the electronic camera 1, the DSP 33 repeatedly operates the CCD 20 while adjusting the exposure time (exposure value) until the exposure level of CCD 20 becomes an appropriate value. At this time, it is also acceptable for the DSP 33 to first operate the photometry circuit 51 and to calculate an initialization value of the exposure time of the CCD 20 in response to the light-receiving level detected by the photometry element 16. By so doing, it is possible to perform adjustment of the exposure time of the CCD 20 in a short period of time.

In addition, the DSP 33 performs timing management of the data input/output such as recording to the memory card 24 and storing decompressed image data to the buffer memory 36.

The buffer memory 36 is used to accommodate the difference between the processing speed in the CPU 39 and the DSP 33 and the speed of the input/output of data to the memory card 24.

The microphone 8 inputs sound information (collects sound) and supplies the sound information to the A/D and D/A converter 42.

After the A/D and D/A converter 42 converts the analog signal corresponding to the sound that has been detected by the microphone 8 to a digital signal, the digital signal is output to the CPU 39. Conversely, sound data that has been supplied from the CPU 39 is converted to analog data, and the analog sound data is output to the speaker 5.

The photometry element 16 measures the light amount of the object and its surrounding and outputs the measured result to the photometry circuit 51.

After the photometry circuit 51 performs a specified processing to the analog signal that is the photometry result that has been supplied from the photometry element 16, it is converted to a digital signal, and the digital signal is output to the CPU 39.

The colorimetry element 17 measures the color temperature of the object and its surroundings and the measured result is output to the colorimetry circuit 52.

After the colorimetry circuit 52 performs a specified processing to the analog signal that is the colorimetry result that has been supplied from the colorimetry element 17, it is converted to a digital signal, and the digital signal is output to the CPU 39.

A timer 45 has a clock circuit and outputs data corresponding to a current time to the CPU 39.

A stop driver 53 sets an opening diameter of a stop 54 at a specified value. The stop 54 is disposed between the shooting lens 3 and the CCD 20 and changes the opening of the light incident to the CCD 20 from the shooting lens 3.

The CPU 39 stops the operation of the photometry circuit 51 and the colorimetry circuit 52 in response to the signal from the LCD switch 25 when the LCD cover 14 is open, and operates the photometry circuit 51 and the colorimetry circuit 52 when the LCD cover 14 is closed. Additionally, the CPU 39 stops the operation of the CCD 20 (for example, the electronic shutter operation) until the release switch 10 is placed in a half-pressed state.

When the operation of the CCD 20 is stopped, the CPU 39 controls the photometry circuit 51 and the colorimetry circuit 52, and receives the photometry result of the photometry element 16 and the colorimetry result of the colorimetry element 17. Furthermore, by referring to a specified table, the CPU 39 calculates a white balance adjustment value corresponding to the color temperature that has been supplied from the colorimetry circuit 52, and supplies the white balance adjustment value to the image processor 31.

That is, when the LCD cover 14 is closed, the LCD 6 is not used as an electronic viewfinder, so the operation of the CCD 20 is stopped. The CCD 20 consumes a large amount of electricity, so it is possible to conserve the batteries 21 by thus stopping the operation of the CCD 20. Additionally, when the LCD cover 14 is closed, until the release switch 10 is operated (until the release switch 10 is placed in a half-pressed state), the CPU 39 controls the image processor 31 so that the image processor 31 does not perform various processing. Furthermore, when the LCD cover 14 is closed, until the release switch 10 is operated (until the release switch 10 is placed in a half-pressed state), the CPU 39 controls the stop driver 53 so that the stop driver 53 does not perform an operation such as changing the opening diameter of the stop 54.

In addition to controlling the strobe driving circuit 37 and appropriately emitting light from the strobe 4, the CPU 39 controls the red-eye reduction lamp driving circuit 38 and appropriately emits light from the red-eye reduction lamp 15 prior to emitting light from the strobe 4. Furthermore, when the LCD cover 14 is opened (that is, the electronic viewfinder is used), the CPU 39 preferably does not emit light from the strobe 4. By so doing, it is possible to shoot an object in the state of the image that is displayed on the electronic viewfinder.

According to the time and date data that is supplied from the timer 45, the CPU 39 records the shooting time and date information as header information of the image data in the shot image recording area of the memory card 24 (that is, the shooting time and date is added to the shot image data which is recorded in the shot image recording area of the memory card 24).

Furthermore, after digitized sound information is compressed, the CPU 39 temporarily stores the digitized and compressed sound data to the buffer memory 36, after which it is recorded in a specified area of the memory card 24 (a sound recording area). Furthermore, at this time, the recording time and date is recorded as header information of the sound data in the sound recording area of the memory card 24.

In addition to performing an auto focus operation by controlling the lens driving circuit 30 and moving the shooting lens 3, the CPU 39 controls the stop driver 53 and changes the opening diameter of the stop 54 that is disposed between the shooting lens 3 and the CCD 20.

Furthermore, the CPU 39 controls the in-finder display circuit 40 and displays settings of various operations or the like on the in-finder display element 26. The CPU 39 exchanges data with an external printer or the like through the interface (I/F) 48. Furthermore, CPU 39 receives signals from the operation keys 7 and appropriately processes those signals. When a specified position of the touch tablet 6A is pressed by a pen (pen-type designating member) 41, which is operated by the user, the CPU 39 reads the X-Y coordinates of the position at which the touch tablet 6A has been pressed, and the coordinate data (the line drawing information which will be discussed later) is accumulated in the buffer memory 36. Furthermore, the CPU 39 records the line drawing information that has been accumulated in the buffer memory 36 to the line drawing information recording area of the memory card 24 along with header information of the input time and date of the line drawing information.

Next, various operations of the electronic camera 1 of the present embodiment are explained. First, the electronic viewfinder operation in the LCD 6 of the present device is explained.

When the user places the release switch 10 in a half-pressed state, the DSP 33 determines whether the LCD cover 14 is open from the value of the signal corresponding to the state of the LCD switch 25 supplied from the CPU 39. When it is determined that the LCD cover 14 is closed, the electronic viewfinder operation is not performed. In this case, the DSP 33 stops the processing until the release switch 10 is operated.

Additionally, when the LCD cover 14 is closed, since the electronic viewfinder operation is not performed, the CPU 39 stops the operation of the CCD 20, the image processor 31, and the stop driver 53. Furthermore, when operation of the CCD 20 is stopped, the CPU 39 operates the photometry circuit 51 and the colorimetry circuit 52, and the measurement result is supplied to the image processor 31. The image processor 31 is thus used to control the white balance and the brightness value. Furthermore, when the release switch 10 is operated, CPU 39 operates the CCD 20 and the stop driver 53.

Meanwhile, when the LCD cover 14 is open, the CCD 20 performs the electronic shutter operation at a specified exposure interval, photoelectrically converts the optical image of the object from which the light has been collected by the shooting lens 3, and outputs the image signals obtained by these operations to the image processor 31. After the image processor 31 controls the white balance and the brightness value and performs specified processing to the image signals, the image signals are output to the A/D converter 32. Furthermore, when the CCD 20 is operating, the image processor 31 uses an adjustment value which is used for controlling the white balance and the brightness value, and which has been calculated by using the output of the CCD 20.

Furthermore, the A/D converter 32 converts the image signal (analog signal) to image data, which is a digital signal, and outputs the image data to the DSP 33.

The DSP 33 outputs the image data to the frame memory 35 and displays the image corresponding to the image data on the LCD 6.

Thus, in the electronic camera 1, when the LCD cover 14 is open, the CCD 20 performs the electronic shutter operation at a specified time interval. Every time this happens, the signals which have been output from the CCD 20 are converted to image data, the image data is output to the frame memory 35, and the image of the object is always displayed on the LCD 6 so that the electronic viewfinder operation is performed.

Additionally, as described above, when the LCD cover 14 is closed, the electronic viewfinder operation is not performed, the operation of the CCD 20, the image processor 31, and the stop driver 53 is stopped, and electricity is conserved.

Next, the shooting of the object by this device is explained.

First, the case when the continuous shooting mode changeover switch 13 disposed in the face Y1 is changed to the S mode (the mode that performs only one frame of shooting) is explained. Initially, by changing the power switch 11 shown in FIG. 1 to the side where ON is printed, power is supplied to the electronic camera 1. The object is confirmed in the viewfinder 2, and shooting processing of the object begins when the release switch disposed in the face Y1 is pressed.

Furthermore, when the LCD cover 14 is closed, when the release switch 10 is placed in a half-pressed state, the CPU 39 re-starts the operation of the CCD 20, the image processor 31, and the stop driver 53. When the release switch 10 is placed in a full-pressed state, the shooting processing of the object begins.

The optical image of the object observed by the viewfinder 2 is light-collected by the shooting lens 3 and is image-formed on the CCD 20, which is provided with a plurality of pixels. The optical image of the object that has been image-formed by the CCD 20 is photoelectrically converted to an image signal at each pixel and is sampled by the image processor 31. The image signals that have been sampled by the image processor 31 are supplied to the A/D converter 32, where they are digitized, and are then output to the DSP 33.

After the image data is temporarily output to the buffer memory 36, the DSP 33 reads the image data from the buffer memory 36. The image data is compressed according to the JPEG (Joint Photographic Experts Group) method, which is a combination of discrete cosine transformation, quantization, and Huffman encoding, and is recorded to the shot image recording area of the memory card 24. At this time, in the shot image recording area of the memory card 24, the shooting time and date data is recorded as header information of the shot image data. Furthermore, the information concerning the shooting environment, which indicates the environment during the shooting, is also recorded in the memory card 24. The information concerning the shooting environment is, for example, information indicating whether a strobe has been used, or whether it is a back-lit environment.

Furthermore, when the continuous shooting mode changeover switch 13 is changed to the S mode, only one frame of shooting is performed. Even if the release switch 10 continues to be pressed, no further shooting is performed after one frame is shot. Furthermore, if the release switch 10 continues to be pressed, the shot image is displayed on the LCD 6 when the LCD cover 14 is open.

Secondly, the case is explained in which the continuous shooting mode changeover switch 13 is changed to the L mode (the mode that performs 8 frames of continuous shooting per second). The power switch 11 is changed over to the side where ON is printed, the power is supplied to the electronic camera 1, and the process of shooting the object begins when the release switch 10, which is disposed in the face Y1, is pressed.

When the LCD cover 14 is closed and the release switch 10 is placed in a half-pressed state, the CPU 39 re-starts the operation of the CCD 20, the image processor 31, and the stop driver 53. When the release switch 10 is placed in a full-pressed state, the process of shooting the object begins.

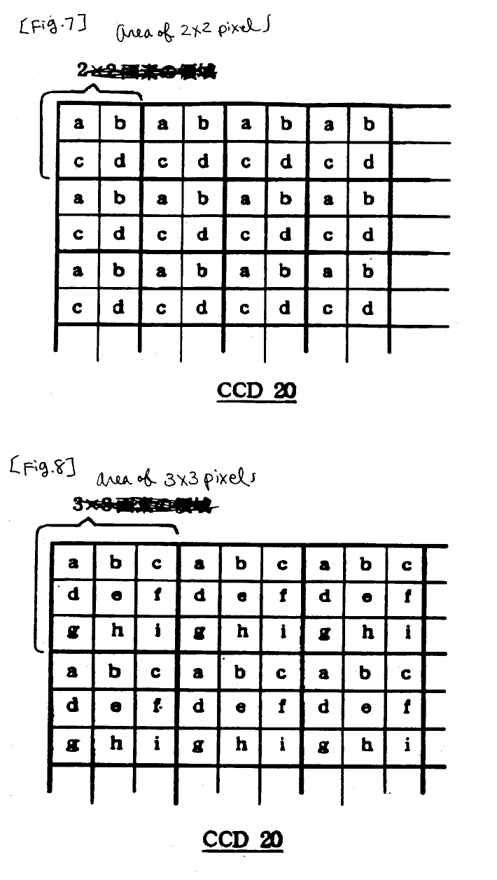

The optical image of the object observed in the viewfinder 2 is light-collected by the shooting lens 3 and is image-formed on the CCD 20, which is provided with a plurality of pixels. The optical image of the object that has been image-formed by the CCD 20 is photoelectrically converted to an image signal in each pixel and is sampled by the image processor 31 at the rate of 8 times per second. Furthermore, at this time, the image processor 31 thins out ¾ of the signals out of the image electrical signals of all the pixels of the CCD 20. That is, as shown in FIG. 7, the image processor 31 divides the pixels of the CCD 20, which are arranged in a matrix, into areas of 2×2 pixels (four pixels). The image signal of one pixel disposed in a specified position is sampled from one of the areas, and the remaining three pixels are thinned out.

For example, in the first sampling (first frame), pixel “a” in the upper left corner of each area is sampled, and the other pixels “b”, “c”, and “d” are thinned out. During the second sampling (second frame), pixel “b” in the upper right corner of each area is sampled, and the other pixels “a”, “c” and “d” are thinned out. Hereafter, during the third and fourth samplings, pixel “c” in the lower left corner and pixel “d” in the lower right corner are sampled, respectively, and the other pixels are thinned out. That is, each pixel is sampled every four frames.

The image signals (the image signals of ¼ of the pixels among all the pixels of the CCD 20) that have been sampled by the image processor 31 are supplied to the A/D converter 32, digitized there, and are output to the DSP 33. After the digitized image signals are temporarily output to the buffer memory 36, the DSP 33 reads the image signals. After being compressed according to the JPEG method, the shot image data that has been digitized and compressed is recorded to the shot image recording area of the memory card 24. At this time, the shooting time and date data is recorded in the shot image recording area of the memory card 24 as header information of the shot image data.

Thirdly, the case is explained in which the continuous shooting mode changeover switch 13 is changed over to the H mode (the mode that performs 30 frames of continuous shooting per second). The power switch 11 is changed over to the side where ON is printed and the power is supplied to the electronic camera 1. When the release switch 10 disposed in the face Y1 is pressed, the process of shooting the object begins.

When the LCD cover 14 is closed and the release switch 10 is placed in a half-pressed state, the CPU 39 re-starts the operation of the CCD 20, the image processor 31, and the stop driver 53. When the release switch 10 is placed in a full-pressed state, the process of shooting the object begins.

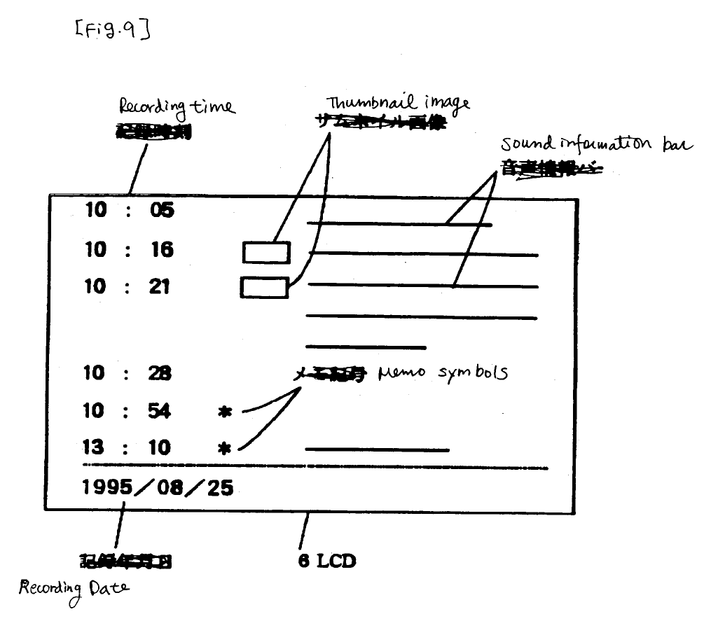

The optical image of the object observed in the viewfinder 2 is light-collected by the shooting lens 3 and is image-formed on the CCD 20. The optical image of the object that has been image-formed on the CCD 20, which is provided with a plurality of pixels, is photoelectrically converted to an image signal in each pixel and is sampled by the image processor 31 at the rate of 30 times per second. Furthermore, at this time, the image processor 31 thins out 8/9 of the signals out of the electrical signals of all the pixels of the CCD 20. That is, as shown in FIG. 8, the image processor 31 divides the pixels of the CCD 20, which are arranged in a matrix, into areas of 3×3 pixels. The image electrical signal of one pixel that is disposed in a specified position is sampled at a rate of 30 times per second from one area and the remaining 8 pixels are thinned out.

For example, during the first sampling (first frame), pixel “a” in the upper left corner of each area is sampled, and the other pixels “b” through “i” are thinned out. During the second sampling (second frame) pixel “b”, which is disposed to the right of pixel “a”, is sampled, and the other pixels “a” and “c” through “i” are thinned out. Hereafter, during the third sampling and after, pixels “c”, “d”, etc. are sampled, respectively, and the other pixels are thinned out. That is, each pixel is sampled every 9 frames.

The image signals (the image signals of 1/9 of all pixels of the CCD 20) that have been sampled by the image processor 31 are supplied to the A/D converter 32, digitized there, and are output to the DSP 33. After the digitized image signals are temporarily output to the buffer memory 36, the DSP 33 reads the image signals. After the image signals are compressed according to the JPEG method, the digitized and compressed shot image data has the shooting time and date header information added to it, and is recorded to the shot image recording area of the memory card 24.

Furthermore, as needed, it is possible to operate the strobe 4 and emit light toward the object. However, when the LCD cover 14 is opened, that is, when the LCD 6 performs the electronic viewfinder operation, the CPU 39 preferably controls the strobe 4 so that the strobe 4 does not emit light.

Next, the case is explained in which two-dimensional information (pen input information) is input from the touch tablet 6A.

When the touch tablet 6A is pressed by the tip of the pen 41, the X-Y coordinates of the place that has been contacted are input to the CPU 39. The X-Y coordinates are stored in the buffer memory 36. Furthermore, the CPU 39 writes data in the frame memory 35 in places corresponding to each point of the above-mentioned X-Y coordinates and displays a line drawing, corresponding to the contact of the pen 41 at the above-mentioned X-Y coordinates, on the LCD 6.

As mentioned above, the touch tablet 6A is structured by a transparent member. Thus, the user can observe the point displayed on the LCD 6 (where the pen 41 is pressed by the tip of the pen) and can feel as if he or she were directly inputting the point by pen on the LCD 6. Furthermore, when the pen 41 is moved on the touch tablet 6A, a line that follows the movement of the pen 41 is displayed on the LCD 6. Furthermore, when the pen 41 is intermittently moved on the touch tablet 6A, a broken line that follows the movement of the pen 41 is displayed on the LCD 6. As described above, the user inputs desired line drawing information such as characters and figures on the touch tablet 6A (LCD 6).

Additionally, when a shot image is displayed on the LCD 6, if line drawing information is input by the pen 41, the line drawing information is combined with the shot image information in the frame memory 35 and is simultaneously displayed on the LCD 6.

Furthermore, by operating a color selection switch (not shown), the user can select the color of the line drawing to be displayed on the LCD 6 from among colors such as black, white, red and blue.

After inputting the line drawing information to the touch tablet 6A by the pen 41, when the execution key 7B of the operation keys 7 is pressed, the line drawing information that has been accumulated to the buffer memory 36 is supplied to the memory card 24 along with the input time and date as header information and is recorded in the line drawing information recording area of the memory card 24.

Furthermore, the line drawing information that is recorded to the memory card 24 is information that has been compressed. The line drawing information input to the touch tablet 6A contains a large amount of information having high spatial frequency components. Therefore, if the compression is performed by the JPEG method, which is used for compression of the above-mentioned shot image, compression efficiency is poor and the information amount is not reduced. Thus, a large amount of time is required for compression and decompression. Furthermore, compression by the JPEG method is a non-reversible (lossy) compression, so it is not appropriate for the compression of the line drawing information, which has a small information amount (when the image is displayed on the LCD 6 after decompression, gathering and blurring become obvious, due to missing information).

Therefore, in the present embodiment, the line drawing information is compressed by a run-length method, which is used for facsimile machines or the like. The run-length method is a method to compress line drawing information by scanning the line drawing screen in the horizontal direction, and encoding the lengths of continuous information (points) of each color such as black, white, red, and blue, and the lengths of continuous non-information (parts without pen inputting). By using this run-length method, it is possible to compress the line drawing information as small as possible. Furthermore, when the compressed line drawing information is decompressed, it is possible to suppress the occurrence of missing information. Additionally, when the information amount is relatively small, it is also acceptable to not compress the line drawing information.

Furthermore, as described above, when a shot image is displayed on the LCD 6, if pen inputting is performed, the shot image data is combined with the line drawing information, input by the pen, in the frame memory 35, and the combined image of the shot image and the line drawing is displayed on the LCD 6. On the other hand, in the memory card 24, the shot image data is recorded in the shot image recording area, and the line drawing information is recorded in the line drawing information recording area. Thus, the two pieces of information are recorded in different respective areas, so the user can delete either image (for example, the line drawing) from the combined image of the shooting image and the line drawing. Furthermore, it is also possible to compress the respective image information by individual (different) compression methods.

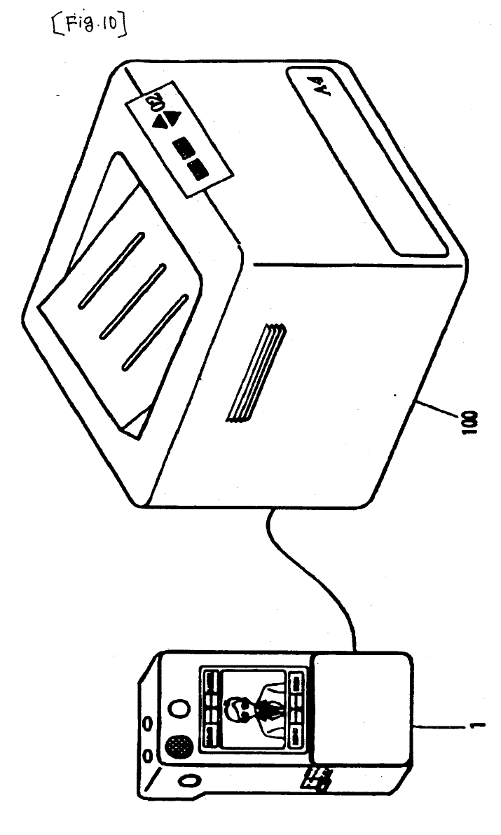

When data is recorded in the sound recording area, the shot image recording area, or the line drawing information recording area of the memory card 24, a specified display is performed on the LCD 6, as shown in FIG. 9.

On the display screen of the LCD 6 shown in FIG. 9, the year/month/date (recording date) of the time at which the information was recorded (in this case, Aug. 25, 1995) is displayed at the lower part of the screen. The recording times of the information that was recorded in that recording year/month/date are displayed at the far left side of the screen.

To the right of the recording times, thumbnail images are displayed. These thumbnail images are created by thinning out (reducing) bit map data of each image data of the shot image data that has been recorded in the memory card 24. The information that has this thumbnail display is information including shot image information. That is, shot image information is included in the information recorded (input) at “10:16” and “10:21”. Shot information is not included in the information recorded at “10:05”, “10:28”, “10:54” and “13:10”.

Furthermore, the memo symbol “*” indicates that a specified memo is recorded as line drawing information.

To the right of the display area of the thumbnail images, sound information bars are displayed and a bar (line) having a length corresponding to the length of the recording time is displayed (if sound information is not input, this is not displayed).

The user selects and designates the information to be reproduced by pressing any part of the display line of the desired information on the LCD 6 shown in FIG. 9 with the tip of the pen 41, and then reproduces the selected information by pressing the execution key 7B shown in FIG. 2 with the tip of the pen 41.

For example, when the line shown in FIG. 9 at which “10:05” is displayed is pressed by the pen 41, the CPU 39 reads the sound data corresponding to the selected recording time and date (10:05) from the memory card 24. After the sound data is decompressed, it is supplied to the A/D and D/A converter 42. After the supplied sound data is converted to analog data by the A/D and D/A converter 42, it is reproduced through the speaker 5.

When the shot image data that has been recorded to the memory card 24 is reproduced, the user selects the information by pressing the desired thumbnail image with the tip of the pen 41 and then reproduces the selected information by pressing the execution key 7B.

The CPU 39 instructs the DSP 33 to read out the shot image data corresponding to the selected shooting time and date from the memory card 24. The DSP 33 decompresses the shot image data (compressed shot image data) read from the memory card 24, accumulates the shot image data in the frame memory 35 as bit map data, and displays the data on the LCD 6.

An image that has been shot in the S mode is displayed on the LCD 6 as a still image. Needless to say, for the still image, the image signals of all the pixels of the CCD 20 are reproduced.

An image that has been shot in the L mode is continuously displayed (i.e., as a moving picture) on the LCD 6 at the rate of 8 frames per second. At this time, the number of pixels displayed in each frame is ¼ of all the pixels of the CCD 20.

Usually, human eyes sensitively respond to deterioration of the resolution of a still image, so the user perceives thinning out of the pixels of the still image as a deterioration of the image quality. However, when the shooting speed increases during continuous shooting, 8 frames of shooting are performed per second in the L mode, and the image is reproduced at the rate of 8 frames per second, the number of pixels of each frame becomes ¼ of the number of pixels of the CCD 20. However, human eyes observe 8 frames of the image per second, so the information amount that enters the human eyes per second becomes double compared to the case of the still image.

That is, if the number of pixels of one frame of the image that has been shot in the S mode is 1, the number of pixels of one frame of the image that has been shot in the L mode is ¼. When the image shot in the S mode (still image) is displayed on the LCD 6, the information amount to enter the human eyes per second is 1 (=(number of pixels 1)×(number of frames 1)). Meanwhile, when the image shot in the L mode is displayed on the LCD 6, the information amount to enter the human eyes per second is 2 (=(number of pixels ¼)×(number of frames 8)) (that is, twice the amount of information of the still image enters the human eyes). Therefore, even if the number of pixels in one frame is made to be ¼, the user can observe the reproduced image during the reproduction period and will hardly notice any deterioration of the image quality.

Furthermore, in this embodiment, different pixels are sampled in every frame and the sampled pixels are displayed on the LCD 6. A residual image effect occurs in the human eyes, and even if ¾ of the pixels are thinned out per frame, the user can observe an image which has been shot in the L mode and displayed on the LCD 6 while hardly noticing deterioration of the image quality.

Furthermore, an image shot in the H mode is continuously displayed at the rate of 30 frames per second on the LCD 6. At this time, the number of pixels displayed per frame is 1/9 of all the pixels of the CCD 20, but the user can observe the image shot in the H mode and displayed on the LCD 6 while hardly noticing deterioration of the image quality for the same reason as in the case of the L mode.

In this embodiment, when an object is imaged in the L and H modes, the image processor 31 thins out the pixels of the CCD 20 to the degree that the user hardly notices any deterioration of the image quality during reproduction. Because of this, the camera of this embodiment can decrease the load of the DSP 33 and operate the DSP 33 at low speed and at low electrical power consumption. Furthermore, because of this, it is possible to reduce the cost and to consume less electricity in the device.

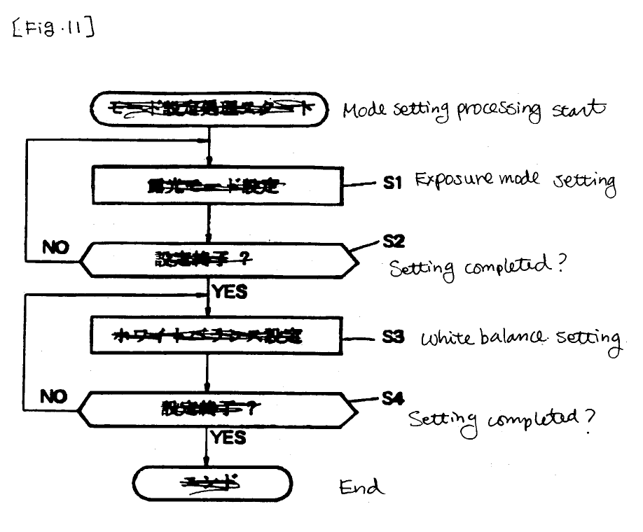

As shown in FIG. 10, the electronic camera 1 of the present embodiment may be connected to an external printer 100 through the printer connecting terminal 18, and can print out a shot image. When printing an image by the printer 100, it is desirable to perform various settings. Hereafter, first, after this type of setting is explained, the printing process will be explained.

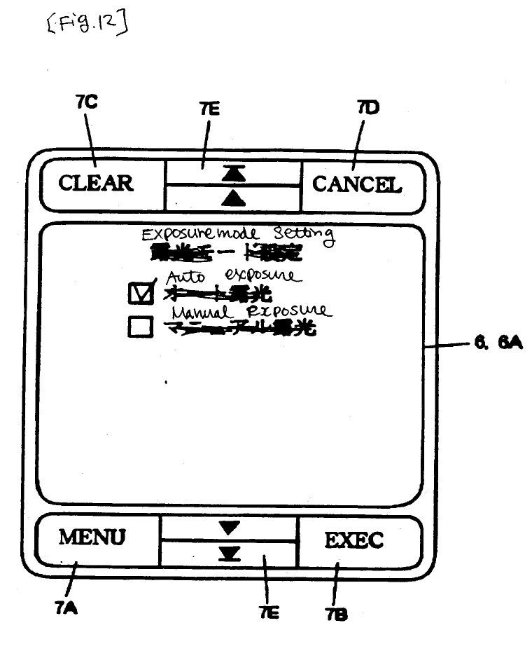

FIG. 11 is a flow chart explaining one example of the mode setting processing. This processing is executed when the processing item “mode setting” is selected on a menu screen (not shown), which is displayed by operating the menu key 7A.

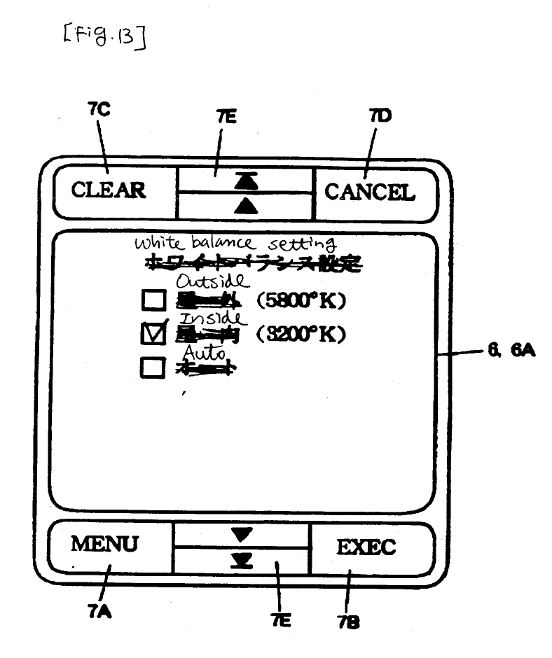

When this processing is executed, the CPU 39 of the electronic camera 1 performs setting of the exposure mode in step S1. That is, the CPU 39 displays the inputting screen shown in FIG. 12 on the LCD 6 and receives the exposure mode setting. In this display example, by checking either of “auto exposure” or “manual exposure” displayed under the heading “exposure mode setting”, it is possible to select the desired mode. The auto exposure mode is a mode in which settings such as shutter speed and stop value are automatically performed. On the other hand, the manual exposure mode is a mode in which the user performs settings such as shutter speed and stop value.

The data that has been input on the screen of FIG. 12 is read by the CPU 39 and is stored as setting information in a specified area of the memory card 24.

In step S2, it is determined whether setting is completed. As a result, if it is determined that setting is not completed (NO), the program returns to step S1, and the same processing as described earlier is repeated until the setting is completed. If it is determined that the setting is completed (YES), the program proceeds to step S3.

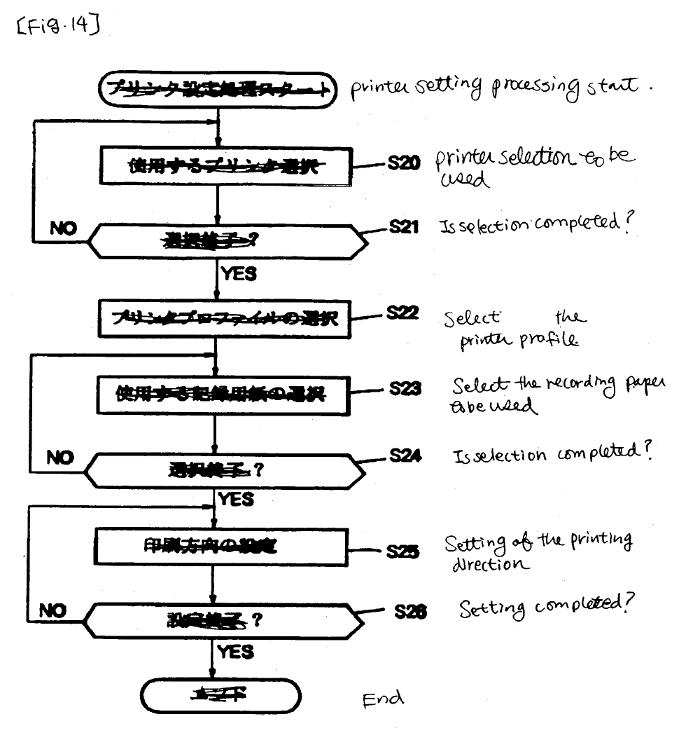

In step S3, the CPU 39 displays the screen shown in FIG. 13 on the LCD 6 and receives the inputting of the setting value concerning the white balance. That is, when shooting is performed outside, 5800° K is set as the white color point. Additionally, if shooting is performed inside, 3200° K is set as the white color point. Furthermore, if the setting of the white color point is to be automatically performed by the electronic camera 1, it is set as auto. The set data is stored as setting information in a specified area of the memory card 24, as described earlier.

In step S4, it is determined whether setting is completed. As a result, if it is determined that setting is not completed (NO), the program returns to step S3 and the same processing as described earlier is repeated until setting is completed. If it is determined that setting is completed (YES), the processing is completed (END).

It is possible to set various modes during the shooting of the electronic camera 1 by the above processing. Furthermore, the setting information that has been thus set is recorded in the memory card 24 in correlation with the shot image every time shooting is performed. Therefore, when a specified shot image is designated, it is also possible to refer to the setting information that was set when the shot image was shot.

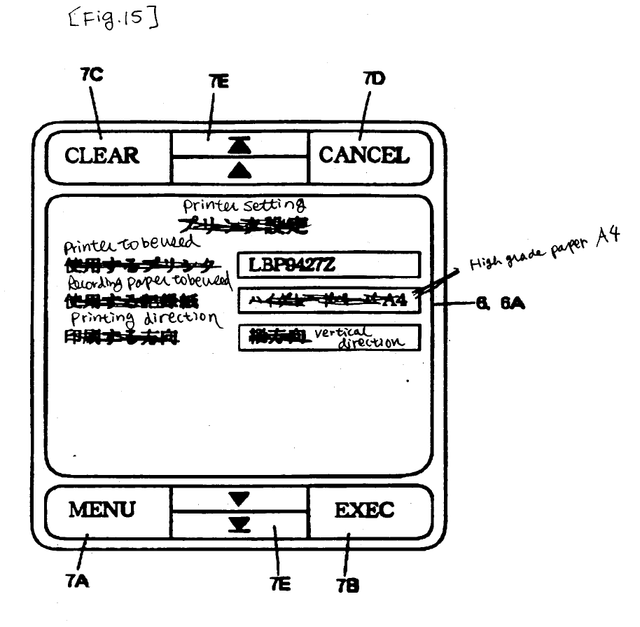

Next, by referring to FIG. 14, an explanation is given of the processing to perform various settings relating to the printer 100.

FIG. 14 is a flow chart explaining one example of the processing performed when various settings relating to the printer 100 are performed. This processing is performed when the processing item “printer setting” is selected on the menu screen (not shown), which is displayed by operating the menu key 7A.

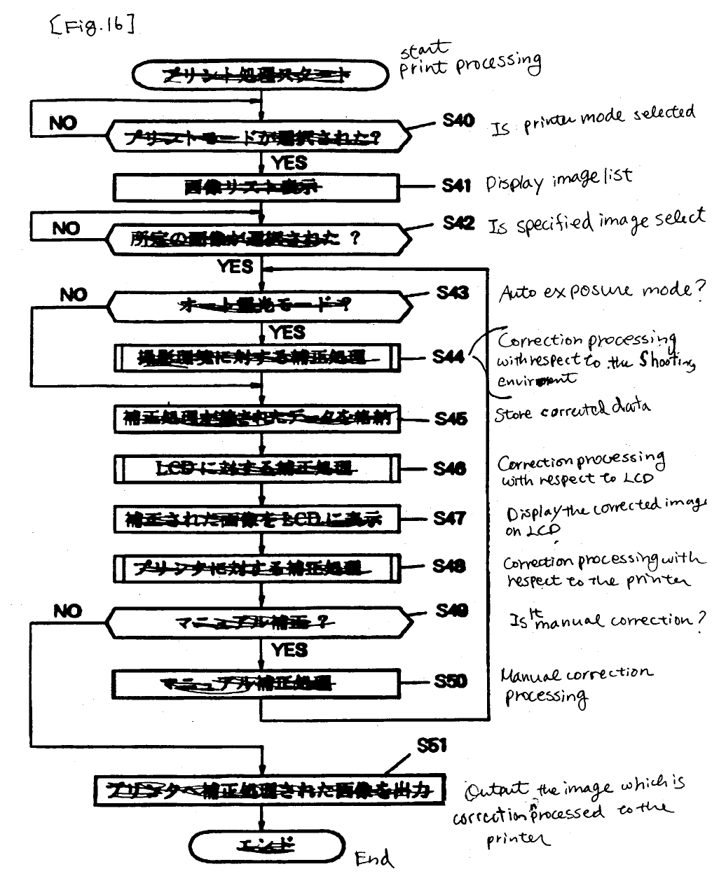

When this processing is performed, the CPU 39 displays the screen shown in FIG. 15 on the LCD 6 in step S20 and receives the setting of the type of printer to be used.

That is, in the display example of FIG. 15, the setting item “printer to be used” is displayed under the heading “printer setting”, and a window is displayed adjacent to the display on the right. By pressing the window part by the pen 41, the user can select a desired printer from among a list (not shown) that is displayed. In this example, “LBP 9427Z” is displayed as the selected printer.

In step S21, it is determined whether the setting of the type of printer to be used is completed. As a result, when it is determined that the type of the printer to be used is not set (NO), the program returns to step S20, and the same processing as described earlier is repeated until the setting is completed. When it is determined that the setting of the type of printer to be used is completed (YES), the program returns to step S22.

In step S22, a profile corresponding to the type of printer that has been set in step S20 is selected. Furthermore, this profile is a file that is structured by data, such as a processing program and various parameters, to correct a balance of color characteristics that each printer has so that the appearance of the color of an image that has been printed out can be the same as the corresponding original image.

Next, in step S23, the CPU 39 receives the input of information concerning the recording paper to be used. In other words, the desired type of recording paper is designated from a list (not shown in the figure) that is displayed by pressing the window to the right of the setting item “recording paper to be used”, which is shown in FIG. 15, with pen 41. In this example, “high grade paper A4” is selected.

Then, the program proceeds to step S24, and it is determined whether the selection of the recording paper is completed. As a result, when the selection of the recording paper is not completed (NO), the program returns to step S23 and the same processing as described above is repeated until the selection is completed. When it is determined that the selection of the recording paper is completed (YES), the program proceeds to step S25.

In step S25, the CPU 39 receives the input of the direction of printing of the image on the recording paper. In other words, as shown in FIG. 15, the desired printing direction is selected from a list (not shown in the figure) that is displayed by pressing the window displayed at the right of the setting item “printing direction” with pen 41. In this example, the vertical direction is selected.

In step S26, it is determined whether the setting of the printing direction is completed. As a result, when it is determined that the setting is not completed (NO), the program returns to step S25, and the same processing as described above is repeated until the setting is completed. When it is determined that the setting is completed (YES), the processing is completed (END).

The information that is input as described above is stored as setting information in a specified area in the memory card 24, and is referenced when the printer 100 is used.

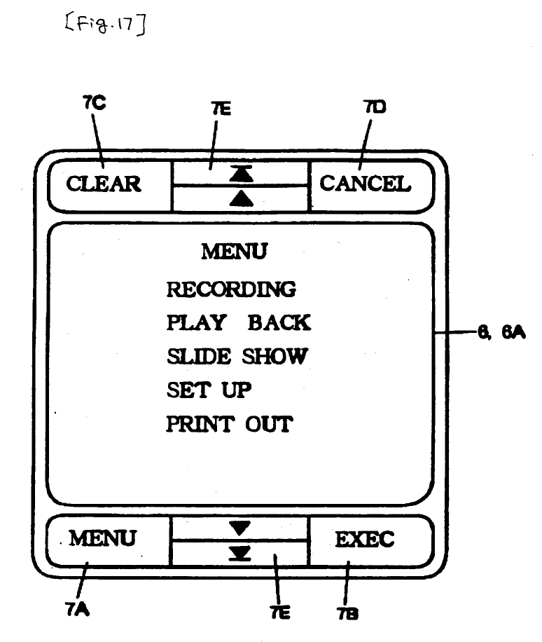

Next, the processing is explained, with reference to FIG. 16, for the situation when a shot image is printed by the printer 100 after the above-mentioned setting has been performed.

FIG. 16 is a flow chart that explains one example of the processing when a shot image is printed by the printer 100.

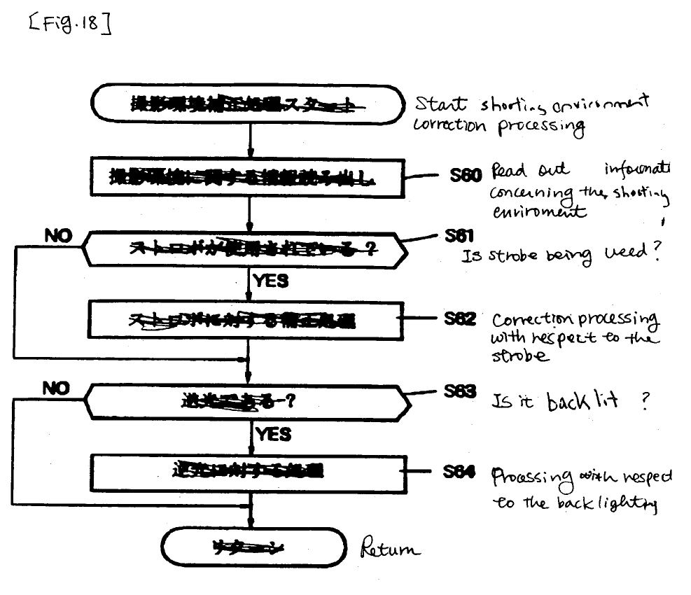

When this processing is executed, in step S40, the CPU 39 determines whether the print mode is selected. In other words, the CPU 39 determines whether “PRINT OUT” (print mode) is selected on the menu screen of FIG. 17, which is displayed by pressing the menu key 7A. As a result, when it is determined that the print mode is not selected (NO), the program returns to step S40, and processing similar to that of the above-mentioned case is repeated until the print mode is selected. When it is determined that the print mode is selected (YES), the program proceeds to step S41.

In step S41, the CPU 39 causes the LCD 6 to display an image list of the shot images, such as the list shown in FIG. 9. Then, the program proceeds to step S42.

In step S42, the CPU 39 determines whether a specified image is selected on the list of shot images shown in FIG. 9. In other words, the CPU 39 determines whether the execution key 7B is pressed after a specified thumbnail image is selected by pen 41 in the screen of the list of shot images shown in FIG. 9. As a result, when it is determined that a specified shot image is not selected (NO), the program returns to the step S42, and processing the same as in the above-mentioned case is repeated until an image is designated. When it is determined that a specified image is designated (YES), the program proceeds to step S43.

In step S43, the CPU 39 determines whether the selected image was shot in the auto-exposure mode. In other words, the CPU 39 reads out the setting information of the selected image from the memory card 24 and determines whether the image was shot in the auto-exposure mode. As a result, when it is determined that the selected image was shot in the auto-exposure mode (YES), the program proceeds to step S44. When it is determined that the image was not shot in the auto-exposure mode (NO), the program proceeds to step S45.

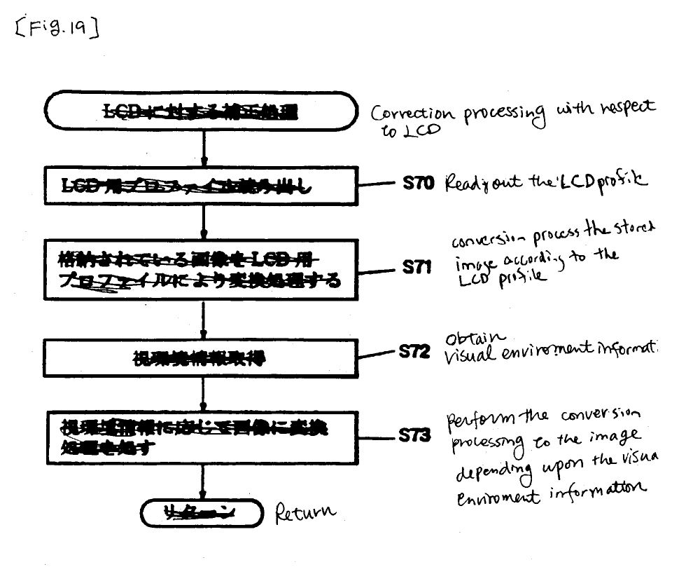

The processing of step S44 is a subroutine, the details of which are explained with reference to FIG. 18.

When the processing of step S44, which is shown in FIG. 16, is executed, the processing shown in FIG. 18 is called out, and is executed. When this processing is executed, in step S60, the CPU 39 performs a read-out of information concerning the shooting environment (hereafter, shooting environment information). In other words, the CPU 39 reads out the shooting environment information stored in the memory card 24. This shooting environment information, as described above, includes, for example, information that shows whether a strobe was used at the time of shooting, and/or information that shows whether it was a backlit condition.

In step S61, the CPU 39 determines whether the selected shot image was shot using a strobe by referring the shooting environment information. As a result, when it is determined that the strobe was not used (NO), the program proceeds to step S63. When it is determined that the strobe was used (YES), the program proceeds to step S62.

In step S62, the CPU 39 activates a program of correction processing, with respect to the strobe, which is included in the profile of the printer selected in step S22 of FIG. 14, and performs correction processing to the image data that is to be printed. This correction processing is to reduce the blue component of the image. In other words, when the strobe is used, the blue component included in the image is enhanced, and processing to reduce the blue component is performed in order to correct that problem.

In step S63, the CPU 39 determines whether an image to be printed was shot in a backlit condition. As a result, when it is determined that the image was not shot in a backlit condition (NO), the program returns to the processing of step S44. When it is determined that the image was shot in a backlit condition (YES), the program proceeds to step S64.

In step S64, the CPU 39 activates the program of correction processing of backlighting, which is included in the profile of the printer selected in step S22 of FIG. 14, and performs correction processing to the image data to be printed. This correction processing is to increase the gradation of the dark portion. In other words, when the image is shot in a backlit condition, since the object is shot dark (expressed by the gradation of the dark portion), processing is performed to express the object in more detail and to enhance the object by increasing the gradation corresponding to the dark portion.

When the processing of step S64 is completed, the program returns to the processing of step S44 of FIG. 16.

The processing shown in FIG. 18 is executed only when the shot image is shot in the auto-exposure mode, as determined in the branch processing of step S43. The reason that the correction processing corresponding to the shooting environment is performed only for images that are shot in the auto-exposure mode is that, since an image that is shot in the manual exposure mode is set based on some plan of the user, if the correction processing is automatically performed with respect to this kind of image, it might ignore the intention of the user.

Returning to FIG. 16, in step S45, the CPU 39 stores the image data to which the correction processing has been performed by the processing of FIG. 18 into a specified area (an area to temporarily store the image for printout) of the memory card 24, and the program proceeds to step S46.

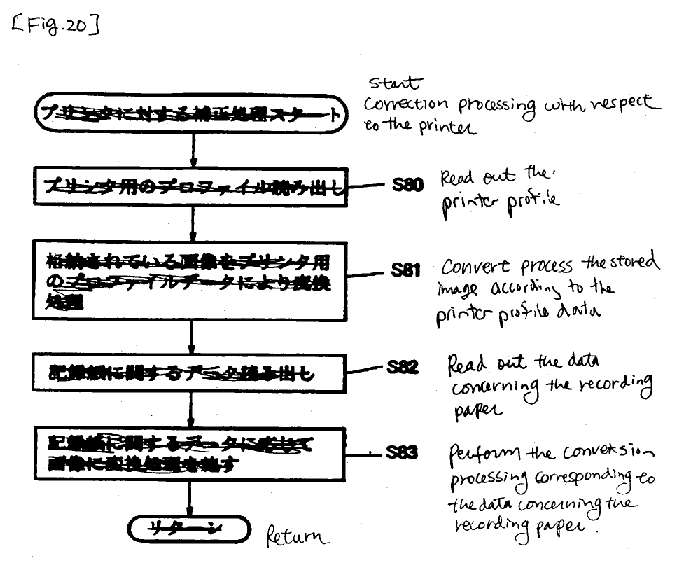

The processing of step S46 is a subroutine, the details of which are explained with reference to FIG. 19.

When the processing of step S46 of FIG. 16 is executed, the processing shown in FIG. 19 is called out and executed. When this processing is executed, in step S70, the CPU 39 reads out the LCD profile, which is composed of various correction programs and data that are necessary when displaying image data from the memory card 24 to the LCD 6. Then, the program proceeds to step S71.

In step S71, the CPU 39 reads out the image data to which the correction processing has been performed corresponding to the shooting environment from the memory card 24, and performs conversion processing based on the LCD profile read out in step S70. In other words, the CPU 39 performs correction processing corresponding to the display characteristics of LCD 6 to the image data in order to make the appearance of the color of the image displayed on LCD 6 close to the color of the original image.

In step S72, the CPU 39 obtains information (hereafter, visual environment information) concerning the current visual environment. In other words, the CPU 39 obtains information concerning the current color temperature that is output from the colorimetry circuit 52, and information concerning the current light amount which is output from the photometry circuit 51.

Next, in step S73, the CPU 39 activates a program of conversion processing corresponding to the visual environment, which is included in the LCD profile read out in step S70. Using this program, the CPU 39 performs further conversion processing to the image data to which the conversion processing was performed in step S71, with reference to the visual environment information obtained in step S72. This processing is, for example, to reset the white balance value according to the information concerning the color temperature output from the colorimetry circuit 52, and to correct the luminance and the gradation according to the information concerning the light amount output from the photometry circuit 51.

The reason why conversion processing corresponding to the visual environment is performed is that since the appearance the color of the image displayed on the LCD 6 differs depending on the color temperature and luminance (visual environment) of surrounding light, it is desirable to perform correction processing corresponding to the visual environment.

When the processing of step S73 is completed, the program returns to the processing of step S47 of FIG. 16.

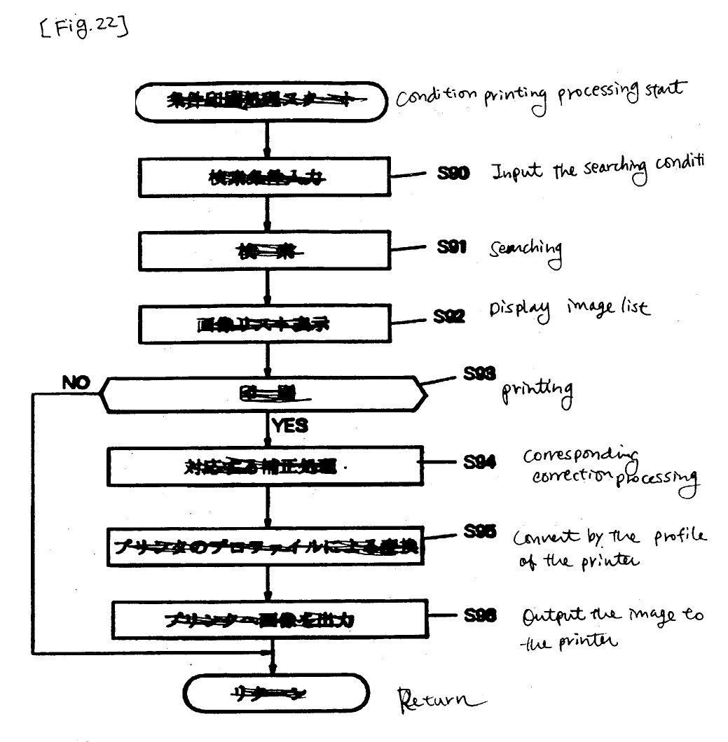

Returning to FIG. 16, in step S47, the CPU 39 displays the image data, to which correction processing has been performed according the display characteristics and visual environment of the LCD 6 by the processing shown in FIG. 19, as shown in FIG. 21. The image that is thus displayed can suppress the influence by the display characteristics of LCD 6 or the influence by the visual environment to a minimum. Therefore, an appearance of the color can be realized that is close to the original image. Then, the program proceeds to step S48.

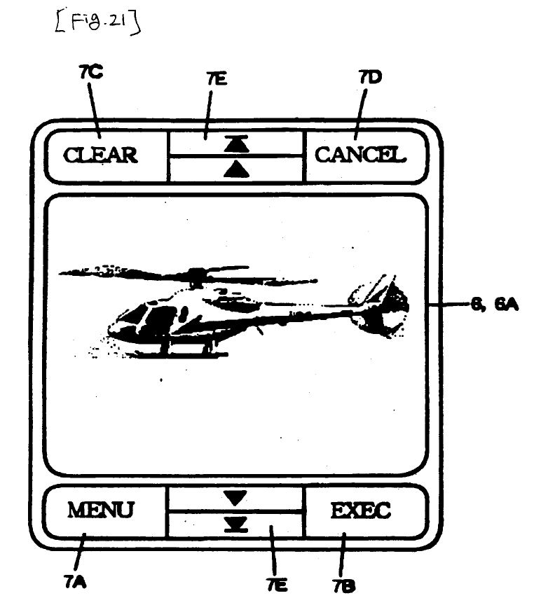

The processing of step S48 is a subroutine, the details of which are explained with reference to FIG. 20.

When the processing of step S48 of FIG. 16 is executed, the processing shown in FIG. 20 is called out and executed. When this processing is executed, in step S80, the CPU 39 reads in the profile corresponding to the printer that was selected in step S20 of FIG. 14 from the memory card 24, and the program proceeds to step S81.

In step S81, the CPU 39 reads out the image data (the image data to which the correction processing corresponding to the shooting environment has been performed) that was stored in the memory card 24 in step S45, and performs conversion processing according to the printer profile read-out in step S80. This conversion, as described above, is to correct the difference in appearance of the color that is caused by the display characteristics of the printer 100.

Next, in step S82, the CPU 39 reads out the white balance value corresponding to the type of the recording paper, which is input by the processing of step S23 of FIG. 14 from the memory card 24. Then, the program proceeds to step S83.

In step S83, the CPU 39 provides the white balance value of the recording paper to a correction processing program corresponding to the recording paper, which is included in the printer profile read out in step S80, as a parameter, and performs correction processing to the image data.

The reason why correction processing corresponding to the recording paper type is thus performed to the image data is to prevent a difference in the appearance of the color of the printed image due to the white balance value of the recording paper.

When the processing of step S83 is completed, the program returns to the processing of step S49 of FIG. 16.

In step S49, the CPU 39 determines whether manual correction processing, in which the user performs correction to the image by manual input, is to be performed. In other words, the CPU 39 determines whether the user has pressed the menu key 7A on the screen on which the image to be printed is displayed, as shown in FIG. 21. As a result, when it is determined that the menu key 7A is not pressed (NO), the program proceeds to the processing of step S51. When it is determined that the menu key 7A is pressed (YES), the program proceeds to step S50.

In step S50, the CPU 39 displays a manual correction processing menu (not shown in the figure) on part of the screen, and receives the selection of processing items. As examples of this manual correction processing, the adjustment of the white balance value, the adjustment of the luminance, the adjustment of the gradation, and/or the like can be selected.

Then, when the manual correction processing is completed, the program returns to the processing of step S43, and the same processing as described above is repeated.

In step S49, when NO is determined, the program proceeds to step S51, and the image data to which the correction processing has been performed is output to the printer 100. At this time, the CPU 39 refers to the size of the recording paper and the printing direction that was set in steps S23 and S25 of FIG. 14, reduces or enlarges the image, if necessary, so that the image fits on the recording paper, and then outputs the image.

According to the above-mentioned embodiment, initially, correction processing is performed to the shot image corresponding to the shooting environment, then correction processing is performed to the image data corresponding to the display characteristics of each display device, and the image data is output as a display. Therefore, it is possible to achieve an appearance of the color that is close to the original image.

Additionally, for the LCD 6, correction processing is performed to the image data based not only on the display characteristics of the device, but also on the visual environment. Additionally, for the printer 100, since the correction processing corresponding to the type of the recording paper is performed to the image data, an image that has the same appearance in color as the image that is displayed on LCD 6 can be printed out by the printer 100.

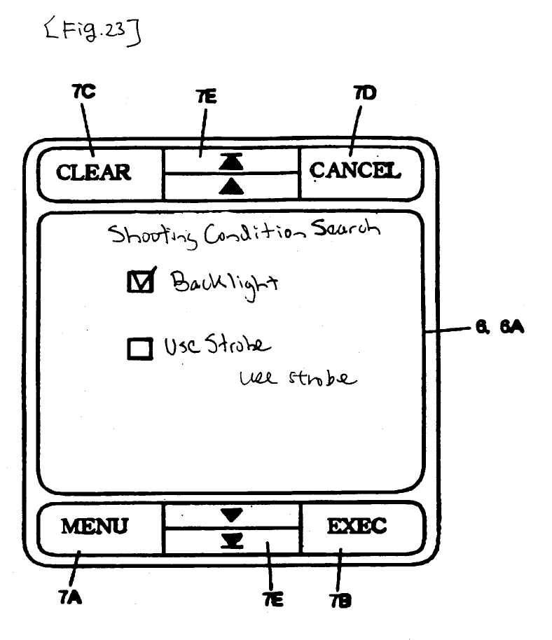

Next, with reference to FIG. 22, processing is explained in which all the shot images that are shot under the same shooting environment are output to the printer 100.

FIG. 22 is a flow chart that explains one example of processing that searches the shot images that are shot under the same environment and outputs all the shot images that are obtained to the printer 100. When this processing is executed in step S90, the CPU 39 of the electronic camera 1 displays the input screen shown in FIG. 23 on the LCD 6, and receives the input of the search conditions. In this display example, “backlight” or “strobe used” is displayed as a search condition under the heading of “shooting condition search”. When backlight is the search condition, as shown in this figure, the inside of a square box displayed to the left of “backlight” is checked. Needless to say, it is appropriate to use, for example, “recording date” or “recording time” instead of using “backlight” or “strobe used” as the search conditions.

In step S91, the shooting environment information that is recorded in the memory card 24 is searched with reference to the search condition input in step S90, and shot images that match the search condition are obtained.

Next, in step S92, the CPU 39 displays the shot images that were obtained in step S91 on the LCD 6 in a list format (not shown in the figure). Then, the program proceeds to step S93.

In step S93, the CPU 39 determines whether a specified input that designates printing is performed. In other words, the CPU 39 determines whether the execution key 7B is pressed. As a result, when it is determined that the execution key 7B is not pressed (NO), the processing is completed (END), and when it is determined that the execution key 7B is pressed (YES), the program proceeds to step S94.

In step S94, the CPU 39 executes the correction processing that corresponds to the search condition. In other words, when the search condition is “backlight”, the CPU 39 performs processing to correct the backlighting (the processing of step S64 of FIG. 18) with respect to each image data. When the search condition is “strobe used”, the CPU 39 performs the processing of step S62, shown in FIG. 18, to each image data.

In step S95, the CPU 39 reads out the profile that corresponds to the printer designated in step S20 at FIG. 14 from the memory card 24, and performs conversion processing to each shot image that was searched in step S91 in accordance with the processing shown in FIG. 20.

Next, in step S96, the CPU 39 outputs the data of shot images to which the conversion processing was performed in step S95 to the printer 100.

According to the above-mentioned processing, it is possible to perform correction processing to all the shot images that require the same correction processing at once, and to output them to the printer 100. Therefore, the time required for the conversion processing can be shortened.

The programs shown in FIGS. 11, 14, 16, 18-20 and 22 are stored in the memory card 24. These programs can be supplied to the user in the condition of being stored in the memory card 24, or can be supplied to the user in the condition of being stored in a CD-ROM (compact disk-ROM) that can be copied.

As explained by using FIG. 19, in the present embodiment, the appearance on the LCD is corrected by performing processing to the image using the LCD profile and visual environment information. It is also acceptable to adjust the color and the balance of brightness of the LCD itself without performing processing to the image.

A computer program that performs the above-mentioned processing can be recorded on a recording medium such as a magnetic disk, CD-ROM or solid-state memory and provided to the user, and it also can be provided by recording a program that is transferred via a communication medium such as a satellite or the like onto a specified recording medium.

Additionally, in the device of the above-mentioned embodiment, all image processing of the image data to be printed is performed in the electronic camera 1, after which the image data is output to the printer 100.

In devices of other embodiments, the shooting environment data is transferred to the printer 100 with image data from the electronic camera 1. The printer 100 uses an image processing circuit that is provided in the printer 100 to perform image processing based on the shooting environment data, and performs printing. It is also acceptable to perform the image processing by dividing the work between the electronic camera 1 and the printer 100, without performing all of the image processing in the printer 100.

Furthermore, in devices of other embodiments, a personal computer or the like is connected between the electronic camera 1 and the printer 100. The electronic camera 1 transfers the image data and the shooting environment data to the personal computer. The personal computer performs image processing to the image data based on the shooting environment data, and transmits it to the printer 100. The printer 100 prints the image data that is transmitted from the personal computer.

What is claimed is:

1. An electronic camera that records or replays an optical image of an object, comprising:
a converter that converts an optical image of the object into image data;
a memory that records the image data obtained by the converter;
a reader that reads out desired image data that is recorded in the memory;
a selector that selects a desired display device to display the image data that is read out by the reader;
a processor that performs image processing corresponding to the display device that is selected by the selector to the image data that is read out by the reader; and
an output part that outputs the image data to which the image processing is performed by said processor to the display device that is selected by the selector.

2. The electronic camera of claim 1, further comprising:
an obtaining part that obtains information concerning a shooting environment when the memory records the image data;
a second memory that records the information concerning the shooting environment that is obtained by the obtaining part; and
a second processor that performs specified image processing to the image data according to the information concerning the shooting environment that is recorded in the second memory.

3. The electronic camera of claim 1, wherein the processor further performs image processing corresponding to a display medium of the display device that is selected by the selector.

4. The electronic camera of claim 1, wherein the display device is a printer.

5. A method of controlling an electronic camera that records or replays an optical image of an object, comprising the steps of:
converting an optical image of an object into a corresponding image data;
recording the obtained image data;
reading out specified image data from the image data that is recorded;
selecting a display device to display the read-out image data;
performing image processing corresponding to the selected display device to the read-out specified image data; and
outputting the image data to which image processing has been performed to the selected display device.

6. A recording medium on which is recorded a control program that is used in an electronic camera that records or replays an optical image of an object, the control program comprising:
a conversion procedure that converts an optical image of an object into corresponding image data;
a recording procedure that records the obtained image data;
read-out procedure that reads out specified image data from the image data that is recorded;
a selection procedure that selects a display device to display the read-out image data;
an image processing procedure that performs image processing corresponding to the selected display device to the read-out specified image data; and
an output procedure that outputs the image data to which the image processing is performed to the selected display device.

7. An electronic camera that is connectable to a plurality of display devices, and that outputs an optical image of a recorded object to at least one of the plurality of display devices as a display, comprising:
a converter that converts image data corresponding to an optical image of an object;
a memory that records the image data that is obtained by the converter;
a reader that reads-out desired image data that is recorded in the memory;
a selector that selects a first display device that displays the image data that is read out by the reader; and
a processor that performs processing so that an appearance of a color of the image that is displayed on the first display device that is selected by the selector and an appearance of an image that is displayed on a second display device that is different from the first display device will be the same.

8. The electronic camera of claim 7, further comprising:
a controller that controls the processor, wherein the controller causes the processor to execute processing according to an operation mode of the electronic camera.

9. The electronic camera of claim 7, further comprising:
an input part that inputs information concerning a visual environment of the second display device, wherein the processor further performs processing corresponding to the information concerning the visual environment that is input by the input part.

10. A method of controlling an electronic camera that is connectable to a plurality of display devices, and that outputs an optical image of a recorded object to at least one of the plurality of display devices as a display, comprising the steps of:
converting an optical image of an object to corresponding image data;
recording the obtained image data;
reading out desired image data from among the recorded image data;
selecting a first display device that displays the read out image data; and
performing processing so that an appearance of a color of the image that is displayed on the selected first display device and an appearance of an image that is displayed on a second display device that is different from the first display device are the same.

11. A recording medium on which is recorded a control program that is used in an electronic camera that is connectable to a plurality of display devices, and that outputs an optical image of a recorded object to at least one of the plurality of display devices as a display, the control program comprising:
a conversion procedure that converts an optical image of an object to corresponding image data;
a recording procedure that records the obtained image data;
a read-out procedure that reads out desired image data from among the recorded image data;
a selection procedure that selects a first display device to display the read out image data; and
a processing procedure that performs processing so that an appearance of a color of the image that is displayed on the selected first display device and an appearance of an image that is displayed on a second display device that is different from the first display device are the same.

12. An electronic camera that records or replays an optical image of an object, comprising:
a converter that converts an optical image of the object into corresponding image data;
an obtaining part that obtains shooting environment data from when the object was shot;
a memory that correlates and records the shooting environment data obtained by the obtaining part to the image data that is obtained by the converter,
an input part that inputs desired shooting environment data;
a searching part that searches for image data that corresponds to the shooting environment data that is input from the input part; and
an output part that outputs shot image data that is located by the searching part to a display device.

13. A method of controlling an electronic camera that is capable of recording or replaying an optical image of an object, comprising the steps of:
converting an optical image of an object to corresponding image data;
obtaining shooting environment data from when the object was shot;
correlating and recording the shooting environment data to the image data that is obtained by the converting step;
inputting desired shooting environment data;
searching for image data corresponding to the input shooting environment data; and
outputting image data located by the searching step to a display device.

14. A recording medium on which is recorded a control program that is used in an electronic camera that is capable of recording or replaying an optical image of an object, the program comprising:
a conversion procedure that converts an optical image of an object into corresponding image data;
a shooting environment obtaining procedure that obtains shooting environment data from when the object was shot;
a correlation procedure that correlates and records the shooting environment data to the image data obtained by the conversion procedure;
an input procedure that inputs desired shooting environment data;
a searching procedure that searches for image data that corresponds to the input shooting environment data; and
an output procedure that outputs the image data located by the searching procedure to a display device.

15. An image processing device that performs image processing to image data that was shot in an electronic camera, comprising:
an image data obtaining part that obtains image data;
an information obtaining part that obtains information that is stored in correlation to the image data; and
an image processor that performs image processing to the image data based on the information stored in correlation to the image data.

16. The image processing device of claim 15, wherein the information stored in correlation to the image data is shooting environment information.

17. An image processing device that performs image processing to image data that was shot in an electronic camera, comprising:
an image data obtaining part that obtains image data;
an information obtaining part that obtains information that is stored in correlation to the image data;
an image processor that performs image processing to the image data; and
a controller that controls whether to perform a specified image processing to the image data, based on the information stored in correlation to the image data.
